(19) United States
(12) Patent Application Publication
(10) Pub. No.: US 2023/0159380 A1
(43) Pub. Date: May 25, 2023

(54) GLASS CERAMIC AND ELECTRONIC COMPONENT

(71) Applicant: TDK CORPORATION, Tokyo (JP)

(72) Inventors: Hidenobu UMEDA, Tokyo (JP); Masaki TAKAHASHI, Tokyo (JP); Kaori SASAKI, Tokyo (JP); Nami ENOMOTO, Tokyo (JP)

(73) Assignee: TDK CORPORATION, Tokyo (JP)

(21) Appl. No.: 17/977,055

(22) Filed: Oct. 31, 2022

(30) Foreign Application Priority Data
Nov. 22, 2021 (JP) 2021-189586

(51) Int. Cl. C03C 14/00; C03C 10/00

(52) U.S. Cl. CPC C03C 14/004; C03C 10/0036; C03C 2214/04; C03C 2214/20; C03C 2204/00

(57) ABSTRACT

A glass ceramic includes feldspar crystal phases, non-crystalline glass phases, Al₂O₃ phases, and SiO₂ phases. At least one pair of the Al₂O₃ phases is bonded via at least one of the feldspar crystal phases.

### TECHNICAL FIELD

The present invention relates to a glass ceramic and an electronic component.

### BACKGROUND

Patent Document 1 discloses an invention of a method of manufacturing a glass ceramic substrate. The glass ceramic includes fillers that partly or entirely contain flat grains.

Patent Document 2 discloses an invention of a multilayer inductor. Inside the multilayer structure is an embedded coil conductor. The multilayer inductor is suitable at a high-frequency range.
Patent Document 1: JP Patent Application Laid Open No. H09-71472
Patent Document 2: JP Patent Application Laid Open No. 2017-73536

### SUMMARY

Ideal inductors have higher impedance at a higher frequency. Unfortunately, the impedance of actual inductors decreases in reciprocal proportion to their stray capacitance at a high frequency range. The stray capacitance of the inductors is in proportion to the permittivity of inductor materials. Thus, low permittivity is demanded of ceramics for radio frequency (RF) inductors used especially at the high frequency range. High strength is also demanded of the RF inductors. In particular, the RF inductors used for vehicles further require higher strength than the RF inductors for other usage.

It is an object of the present invention to provide a glass ceramic or so having low relative permittivity c and high strength.

A glass ceramic according to the present invention includes feldspar crystal phases, non-crystalline glass phases, Al₂O₃ phases, and SiO₂ phases, wherein at least one pair of the Al₂O₃ phases is bonded via at least one of the feldspar crystal phases.

The feldspar crystal phases may mainly include Sr.

Al₂O₃ fillers of the Al₂O₃ phases may have an average aspect ratio of 15 or more and 75 or less.

SiO₂ fillers of the SiO₂ phases may have an average grain size of 0.10 μm or more and 3.0 μm or less.

A value calculated by dividing the area ratio of the feldspar crystal phases by the area ratio of the non-crystalline glass phases may be 0.10 or more and less than 1.00.

The area ratio of the Al₂O₃ phases may be 7.0% or more and 20.0% or less.

The area ratio of the SiO₂ phases may be 10.0% or more and 30.0% or less.

An electronic component according to the present invention includes the above-mentioned glass ceramic.

### BRIEF DESCRIPTION OF THE DRAWING(S)

FIG. 1 is a STEM image of a cross section of a glass ceramic.

FIG. 2 is a phase separation analysis image of the cross section of the glass ceramic.

### DETAILED DESCRIPTION

Hereinafter, an exemplary embodiment of the present invention will be explained in detail with reference to the drawings. The present invention is not to be limited only to the embodiment explained below. Also, constituents described below include the ones that those skilled in the art can easily devise and the ones that are substantially the same. Furthermore, the constituents described below can be combined appropriately.

A glass ceramic 1 of the present embodiment includes feldspar crystal phases 13, non-crystalline glass phases 12, Al₂O₃ phases 14, and SiO₂ phases 11. At least one pair of the Al₂O₃ phases 14 is bonded via at least one of the feldspar crystal phases 13.

The feldspar crystal phases 13 mainly include feldspar crystals. The feldspar crystals include at least one metal element of Group 2 (excluding Be), alumina, and silica, and are represented by a general formula M(Si,Al)₄O₈. “M” includes the at least one metal element of Group 2 (excluding Be). “M” may mainly include Sr. This means that, among all elements included in “M” of the feldspar crystals, Sr may account for the highest proportion in terms of mass. If the feldspar crystal phases 13 mainly include Sr, this also means that Sr accounts for the highest proportion in terms of mass among all elements included in “M” of the feldspar crystals in the feldspar crystal phases 13.

The feldspar crystal phases 13 may include metal oxides in addition to the feldspar crystals. Examples of the metal oxides include Na₂O, K₂O, ZrO₂, and Ag₂O. The proportion of the feldspar crystals in the feldspar crystal phases 13 is not limited and may be, for example, 80 mass % or more.

The non-crystalline glass phases 12 include glass that does not contain crystals. The glass included in the non-crystalline glass phases 12 may have any composition. For example, the non-crystalline glass phases 12 may include oxides of “M”, oxides of Si, oxides of Al, and oxides of B at a total of 70 mass % or more.

The Al₂O₃ phases 14 mainly include Al₂O₃ (alumina) crystals. The proportion of Al₂O₃ in the Al₂O₃ phases 14 is not limited and may be, for example, 97 mass % or more. The SiO₂ phases 11 mainly include SiO₂ (silicon dioxide). The proportion of SiO₂ in the SiO₂ phases 11 is not limited and may be, for example, 97 mass % or more.

The Al₂O₃ phases 14 are bonded via the feldspar crystal phases 13. Not all the Al₂O₃ phases 14 are required to be bonded via the feldspar crystal phases 13. At least one pair of Al₂O₃ phases 14 is bonded via at least one of the feldspar crystal phases 13. In terms of the number of the Al₂O₃ phases 14, 25% or more of the Al₂O₃ phases 14 may be bonded together via the feldspar crystal phases 13.

Having the above-mentioned structure, the glass ceramic of the present embodiment has low relative permittivity ε and high strength.

A glass ceramic including many non-crystalline phases (e.g., the SiO₂ phases 11 and the non-crystalline glass phases 12) readily has low relative permittivity e. However, the glass ceramic including many non-crystalline phases readily has cracks and low strength.

When a glass ceramic simply includes crystal phases (e.g., the Al₂O₃ phases 14), not only the relative permittivity E increases, but also the strength does not improve sufficiently, compared to when the glass ceramic does not include the crystal phases. However, the present inventors have found that, when the glass ceramic includes the feldspar crystal phases 13 in addition to the Al₂O₃ phases 14 and the Al₂O₃ phases 14 are bonded via the feldspar crystal phases 13, the glass ceramic has low relative permittivity E and high strength.

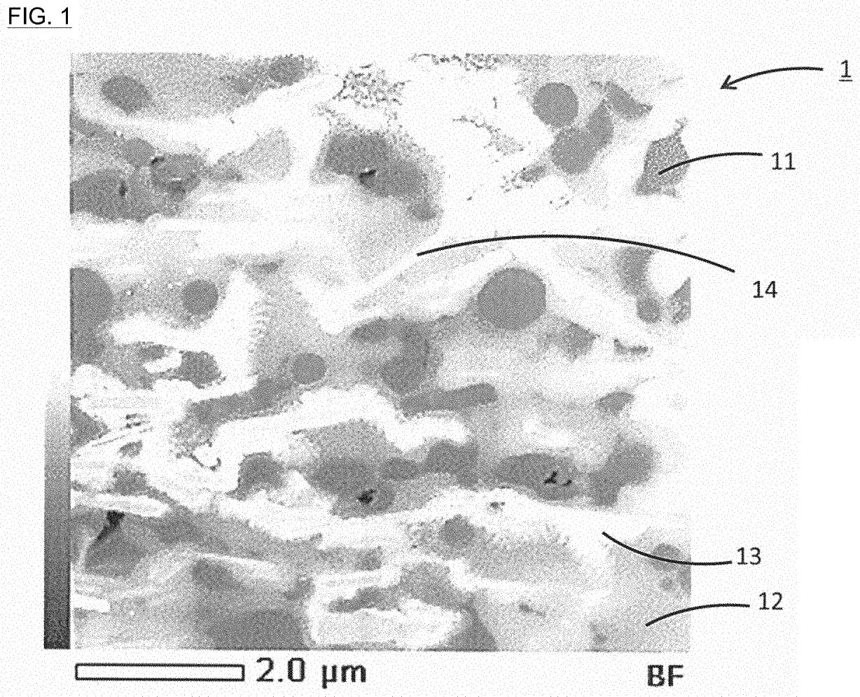

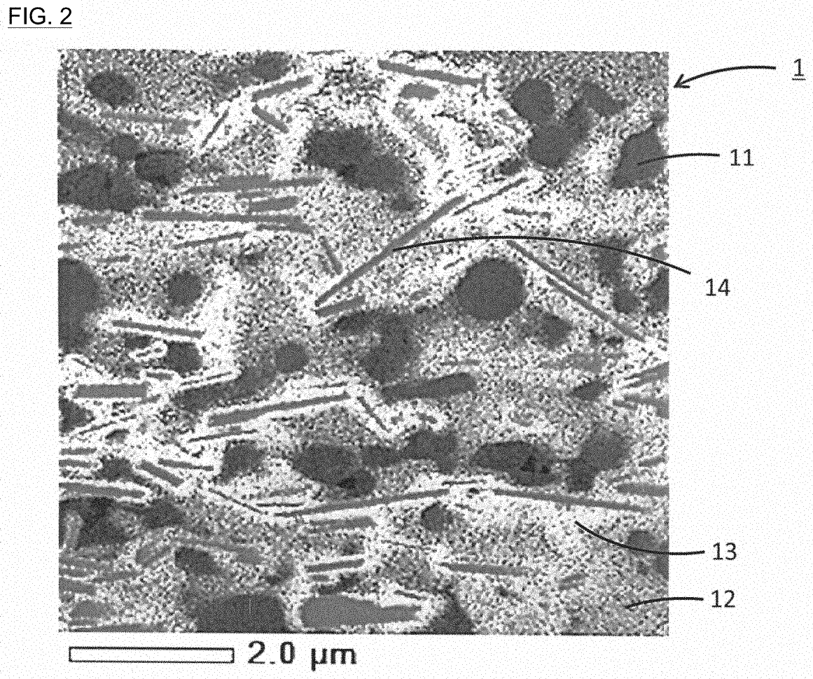

The microstructure of the glass ceramic can be checked by observing its cross section with STEM-EDS or so and further performing phase separation analysis. FIG. 1 is an image (may simply be referred to as a “STEM image”) generated in the observation of a cross section of the glass ceramic of the present embodiment with STEM. FIG. 2 is an image (may simply be referred to as a “phase separation analysis image”) generated through RGB image phase analysis as phase separation analysis of the same field of view as FIG. 1. The field of view may have any size and may be observed at any magnification as long as the microstructure of the glass ceramic is observed without fail. For example, the field of view is 200 μm² or more, and the magnification of the image is 5000× or more. The field of view may include a plurality of fields of view. The total size of the fields of view is, for example, 200 μm² or more.

As shown in FIGS. 1 and 2, the glass ceramic 1 includes the feldspar crystal phases 13, the non-crystalline glass phases 12, the Al₂O₃ phases 14, and the SiO₂ phases 11. In FIG. 1 (STEM image), boundaries between the feldspar crystal phases 13 and the Al₂O₃ phases 14 are not clear. Using both FIG. 1 (STEM image) and FIG. 2 (phase separation analysis image) clarifies the boundaries between the feldspar crystal phases 13 and the Al₂O₃ phases 14. Surrounding the Al₂O₃ phases 14 are the feldspar crystal phases 13 and/or the non-crystalline glass phases 12. At least one pair of Al₂O₃ phases 14 is bonded via the feldspar crystal phases 13.

For identifying the phases, they may be irradiated with an electron beam to measure electron diffraction patterns. When the electron diffraction pattern of the non-crystalline glass phases 12 is measured, only halo patterns attributable to amorphousness are generated, and no spots attributable to crystals are generated. In contrast, when the electron diffraction patterns of the feldspar crystal phases 13 and the Al₂O₃ phases 14 are measured, a number of spots attributable to crystals are generated. When the electron diffraction pattern of the SiO₂ phases 11 is measured, halo patterns attributable to amorphousness and/or spots attributable to crystals are generated.

In the glass ceramic, phases other than the four types of phases, namely the feldspar crystal phases 13, the non-crystalline glass phases 12, the Al₂O₃ phases 14, and the SiO₂ phases 11, may be so small that the phases other than the four can be ignored. For example, the phases other than the four may occupy an area ratio of 5% or less (including 0%).

The glass ceramic may have pores. However, the glass ceramic is so dense that it may have few pores. Having few pores is preferable with regard to improvement of the strength. For example, the pores may occupy an area ratio of 5% or less (including 0%).

Al₂O₃ fillers of the Al₂O₃ phases 14 may have an average aspect ratio of 15 or more and 75 or less. When the average aspect ratio of the Al₂O₃ fillers is within the above-mentioned range, the glass ceramic readily has higher strength than when the average aspect ratio of the Al₂O₃ fillers is smaller than the above-mentioned range. When the average aspect ratio of the Al₂O₃ fillers exceeds 75, the glass ceramic readily has lower sinterability, more pores, and lower strength.

The average aspect ratio of the Al₂O₃ fillers can be calculated by measuring the aspect ratio of each Al₂O₃ phase 14 in the phase separation analysis image and working out the average.

SiO₂ fillers of the SiO₂ phases 11 may have an average grain size of 0.10 μm or more and 3.0 μm or less. The smaller the average grain size of the SiO₂ fillers, the more likely it is to reduce the sinterability, and the less likely it is for the Al₂O₃ phases 14 to be bonded via the feldspar crystal phases 13. The larger the average grain size of the SiO₂ fillers, the more likely it is for a sheet including the glass ceramic to have higher surface roughness.

The average grain size of the SiO₂ fillers can be calculated by measuring the equivalent circular diameter of each SiO₂ phase 11 in the phase separation analysis image and working out the average. The equivalent circular diameter of the SiO₂ phase 11 means the diameter of a circle having the same area as the projected area of the SiO₂ phase 11.

The non-crystalline glass phases 12 mainly include a glass component, and the feldspar crystal phases 13 mainly include a glass component. In the glass ceramic of the present embodiment, the SiO₂ fillers and the Al₂O₃ fillers are dispersed in each glass component.

The value calculated by dividing the area ratio of the feldspar crystal phases 13 by the area ratio of the non-crystalline glass phases 12 may be 0.10 or more and less than 1.00. The smaller the value, the less likely it is for the Al₂O₃ phases 14 to be bonded via the feldspar crystal phases 13. The larger the value, the more likely it is to increase the strength and unfortunately the relative permittivity e.

The area ratio of the Al₂O₃ phases 14 may be 7.0% or more and 20.0% or less. The smaller the area ratio of the Al₂O₃ phases 14, the less likely it is for the Al₂O₃ phases 14 to be bonded via the feldspar crystal phases 13.

The area ratio of the SiO₂ phases 11 may be 10.0% or more and 30.0% or less. The smaller the area ratio of the SiO₂ phases 11, the more likely it is to increase the relative permittivity. The larger the area ratio of the SiO₂ phases 11, the more likely it is to reduce the sinterability, and the less likely it is for the Al₂O₃ phases 14 to be bonded via the feldspar crystal phases 13.

The area ratio of each phase can be calculated by performing image analysis of the phase separation analysis image.

Hereinafter, a method of manufacturing the glass ceramic of the present embodiment, especially a method of manufacturing a glass ceramic element body (glass ceramic sintered body), will be explained.

The glass ceramic element body is manufactured by mixing a glass raw material, a SiO₂ filler raw material, and an Al₂O₃ filler raw material and heating the mixture for sintering.

As the glass raw material, crystallized glass and non-crystalline glass are prepared and mixed.

The crystallized glass includes a component that grows into the feldspar crystals during heating (described later). Examples of the component that grows into the feldspar crystals during heating (described later) include oxides of “M”, oxides of Si, and oxides of Al. The crystallized glass may include other components. The crystallized glass may appropriately include any glass components, such as various oxides (e.g., oxides of B), in addition to the component that grows into the feldspar crystals.

The non-crystalline glass may be of any type. For example, the non-crystalline glass may be glass that includes oxides appropriately selected from various oxides (e.g., oxides of Si, oxides of B, and oxides of K) and does not include crystals. The glass component in the crystallized glass may mostly be included in the feldspar crystal phases 13 in the end, and the non-crystalline glass may mostly be included in the non-crystalline glass phases 12 in the end.

The non-crystalline glass may combine with the crystallized glass during heating (described later). Oxides not included in the non-crystalline glass may be included in the non-crystalline glass phases 12.

When the glass raw material includes only the non-crystalline glass, the feldspar crystal phases 13 are difficult to be generated. When the glass raw material includes only the crystallized glass, it is likely that the non-crystalline glass phases 12 account for a small proportion. Controlling the proportion of each raw material allows the area ratio of each phase to be controlled. In particular, controlling the proportion of the crystallized glass and the non-crystalline glass allows the value calculated by dividing the area ratio of the feldspar crystal phases 13 by the area ratio of the non-crystalline glass phases 12 to be controlled.

The glass raw material may have any particle size. For example, the glass raw material may have a D90 of 1 to 5 μm measured with a laser diffraction type particle size distribution meter.

The Al₂O₃ filler raw material is preferably α-alumina having a relatively high melting point so that the glass ceramic after heating includes the Al₂O₃ phases 14. The Al₂O₃ filler raw material may have a particulate shape or a plate shape. Controlling the shape of the Al₂O₃ filler raw material allows the average aspect ratio of the Al₂O₃ phases 14 to be controlled. For example, the Al₂O₃ fillers have a low aspect ratio when the Al₂O₃ filler raw material has a particulate shape, and have a high aspect ratio when the Al₂O₃ filler raw material has a plate shape. Although part of Al₂O₃ in the Al₂O₃ filler raw material may react with “M” and Si and be incorporated into the feldspar crystal phases 13, a large part of Al₂O₃ in the Al₂O₃ filler raw material is included in the Al₂O₃ phases 14. The higher the aspect ratio of the Al₂O₃ fillers, the more likely it is to increase the surface area of the Al₂O₃ phases 14 (their perimeters in the STEM image) and the area ratio of the feldspar crystal phases 13 in contact with the Al₂O₃ phases 14.

As the SiO₂ filler raw material, quartz glass (amorphous silica) can be used. Controlling the particle size of the SiO₂ filler raw material allows the average grain size of the SiO₂ phases 11 to be controlled. Although part of SiO₂ in the SiO₂ filler raw material may be incorporated into the non-crystalline glass phases 12 or the feldspar crystal phases 13 by heating, a large part of SiO₂ in the SiO₂ filler raw material is included in the SiO₂ phases 11.

Next, the mixed raw materials are mixed in wet manner for 24 hours with a solvent or so normally used in the technical field to give a raw material slurry. The solvent may be alcohol, which is normally used in the technical field. Any device may be used for wet mixing. For example, a ball mill may be used. The raw material slurry is dried until the solvent is removed to give a glass ceramic material. Any device may be used for drying. For example, a spray dryer may be used.

Next, a binder or so normally used in the technical field is added to the glass ceramic material for granulation, and the granulated material is sized into granules with a sieve. The granules are pressure-molded to give a green compact. Then, the green compact is heated in the air to give a glass ceramic element body (glass ceramic sintered body).

By heating, part of SiO₂ in the SiO₂ filler raw material is incorporated into the non-crystalline glass. Also, by heating, the feldspar crystals are generated with Al₂O₃ as a core. Thus, the feldspar crystal phases 13 are generated around the Al₂O₃ phases 14, and the Al₂O₃ phases 14 bond via the feldspar crystal phases 13.

The shorter the heating time, the more likely it is to reduce the value calculated by dividing the area ratio of the feldspar crystal phases 13 by the area ratio of the non-crystalline glass phases 12, and the less likely it is for the Al₂O₃ phases 14 to be bonded via the feldspar crystal phases 13. With a long enough heating time, the Al₂O₃ phases 14 bond via the feldspar crystal phases 13. With a still longer heating time, the SiO₂ phases 11 and the non-crystalline glass phases 12 are reduced and the feldspar crystal phases 13 are increased.

The present invention is not limited to the above-described embodiment, and can variously be modified within the scope of the present invention.

For example, the glass ceramic material may be kneaded with a binder and a solvent normally used in the technical field to give a glass ceramic paste. The glass ceramic paste and a conductor paste including Ag or so may be printed and laminated alternately and then fired to form a laminated body including the glass ceramic and conductors (printing method). Instead, the glass ceramic paste may be used to form green sheets, where an internal electrode paste is to be printed, and the green sheets with internal electrode patterns may be laminated and fired to form a laminated body including the glass ceramic and conductors (sheet method).

When the glass ceramic and the conductors are fired simultaneously as described above, metal (e.g., Ag) in the conductors may be dispersed into the glass ceramic. In that case, oxides of the metal in the conductors are likely to be included in the non-crystalline glass phases 12 and the feldspar crystal phases 13, especially those in the vicinity of the conductors.

The glass ceramic according to the present embodiment may be used for any purpose. For example, the glass ceramic is suitable for electronic components, especially radio frequency (RF) inductors. In particular, the glass ceramic is suitable for RF inductors for vehicles requiring especially high strength.

### Examples

Hereinafter, the present invention will be explained based on more detailed examples, but the present invention is not limited thereto.

### Experiment 1

A glass raw material, a SiO₂ filler raw material, and an Al₂O₃ filler raw material were prepared. As the glass raw material, crystallized glass and non-crystalline glass were prepared. These materials were mixed at a mass ratio shown in Table 1.

The crystallized glass had a Si—Sr—Al-based composition (the amount of SiO₂: 37 to 45 mass %, the amount of SrO: 35 to 40 mass %, the amount of Al₂O₃: 5 to 15 mass %, and the amount of B₂O₃: 1 to 5 mass %).

The non-crystalline glass had a Si—B—K-based composition (the amount of SiO₂: 75 to 84 mass %, the amount of B₂O₃: 15 to 20 mass %, and the amount of K₂O: 1 to 5 mass %).

The SiO₂ filler raw material had an average particle size so that SiO₂ fillers observed in the end had an average grain size shown in Table 2. The Al₂O₃ filler raw material had an average particle size of 1 to 3 μm. The Al₂O₃ filler raw material had an aspect ratio so that Al₂O₃ fillers observed in the end had an average aspect ratio shown in Table 2.

Next, the mixed raw materials were mixed in wet manner with a solvent (99% methanol-denatured ethanol) using a ball mill (media: zirconia balls) for 24 hours to give a raw material slurry. This raw material slurry was dried with a drying machine until the solvent was removed to give a glass ceramic material.

Next, 2.5 parts by mass of an acrylic resin-based binder (Elvacite manufactured by DuPont) was added as a binder to 100 parts by mass of the glass ceramic material for granulation, and they were sized into granules with a 20-mesh sieve. The granules were pressure-molded at 74 MPa (0.75 ton/cm²) to give φ17 disc-shaped green compacts having a diameter of 17 mm and a thickness of 8.5 mm. Then, the green compacts were heated in the air at 900° C. for the time shown in Table 2 to give glass ceramic sintered bodies.

Next, the microstructure and various characteristics of the glass ceramic sintered bodies were evaluated under the following conditions. Table 2 shows the results.

### Microstructure

STEM images of cross sections of the glass ceramic sintered bodies were taken with STEM (JEM-2200FS). Further, phase separation analysis was performed through RGB image phase analysis. Fields of view had a size of 7.5 μm×7.5 μm and were observed at a magnification of 7500×. The fields of view were determined at five different locations for each of the present examples. At each field of view, the STEM image was taken, and phase separation analysis was performed. The five STEM images and the five phase separation analysis images were used to calculate the average grain size of the SiO₂ fillers, the average aspect ratio of the Al₂O₃ fillers, and the area ratio of each phase. Then, a value was calculated by dividing the area ratio of feldspar crystal phases by the area ratio of non-crystalline glass phases.

Whether there were any Al₂O₃ phases bonded via the feldspar crystal phases was checked. Among the present examples, those having any Al₂O₃ phases bonded via the feldspar crystal phases were treated as satisfactory, and those having no such Al₂O₃ phases were treated as unsatisfactory.

In the present examples, the non-crystalline glass did not include oxides of Sr or oxides of Al. However, it was confirmed that the non-crystalline glass phases included in the glass ceramic sintered bodies manufactured in the end included SrO and Al₂O₃.

### Relative Permittivity ε

The relative permittivity ε (no unit) was measured with a network analyzer (8510C manufactured by HEWLETT PACKARD) using a resonance method (JIS R 1627). Among the present examples, those having a relative permittivity ε of 6.20 or less were treated as good, and those having a relative permittivity ε of 6.00 or less were treated as better.

### Sinterability

Fracture surfaces of the glass ceramic sintered bodies were observed with FE-SEM. Among the present examples, those that had few pores and were deemed to be sufficiently densified were treated as satisfactory, and those that had many pores and were not deemed to be sufficiently densified were treated as unsatisfactory.

### Strength

The strength (bending strength) of the glass ceramic sintered bodies was measured in a three-point bending test with a universal testing machine 5543 manufactured by INSTRON. The distance between the points was 15 mm. Among the present examples, those with a bending strength of 100 MPa or more were treated as good.

TABLE 1

| | Glass raw material | | | |
|---|---|---|---|---|
| | | Non-crystalline | Al₂O₃ filler | SiO₂ filler |
| | Crystallized glass | glass | raw material | raw material |
| | (Parts by mass) | (Parts by mass) | (Parts by mass) | (Parts by mass) |
| Composition 1 | 45.5 | 30.0 | 24.5 | 10.0 |
| Composition 2 | 45.5 | 30.0 | 24.5 | 3.0 |
| Composition 3 | 45.5 | 30.0 | 24.5 | 15.0 |
| Composition 4 | 45.5 | 30.0 | 24.5 | 17.5 |
| Composition 5 | 45.0 | 30.0 | 30.0 | 5.0 |
| Composition 6 | 40.0 | 30.0 | 35.0 | 5.0 |
| Composition 7 | 55.0 | 30.0 | 15.0 | 10.0 |

TABLE 2

| | | | Average | | | | | |
|---|---|---|---|---|---|---|---|---|
| | | | grain | Average | Phase area ratio | | | |
| | | | size of | aspect | | Non- | Feldspar | |
| | | Heating | SiO₂ | ratio of | SiO₂ | crystalline | crystal | Al₂O₃ |
| | | time | fillers | Al₂O₃ | phases | glass | phases | phases |
| | Composition | (min) | (μm) | fillers | (%) | phases (%) | (%) | (%) |
| Comparative | Composition 1 | 30 | 0.05 | <2 | 23.0 | 62.0 | 7.0 | 8.0 |
| Example 1 | | | | | | | | |
| Example 1 | Composition 1 | 30 | 0.30 | <2 | 23.0 | 62.0 | 7.0 | 8.0 |
| Example 2 | Composition 1 | 30 | 0.50 | <2 | 23.0 | 62.0 | 7.0 | 8.0 |
| Example 3 | Composition 1 | 30 | 2.5 | <2 | 23.0 | 62.0 | 7.0 | 8.0 |
| Example 4 | Composition 1 | 30 | 4.0 | <2 | 23.0 | 62.0 | 7.0 | 8.0 |
| Example 5 | Composition 2 | 30 | 0.50 | <2 | 5.0 | 76.5 | 8.6 | 9.9 |
| Example 2 | Composition 1 | 30 | 0.50 | <2 | 23.0 | 62.0 | 7.0 | 8.0 |
| Example 6 | Composition 3 | 30 | 0.50 | <2 | 30.0 | 56.4 | 6.4 | 7.3 |
| Comparative | Composition 4 | 30 | 0.50 | <2 | 35.0 | 52.3 | 5.9 | 6.8 |
| Example 2 | | | | | | | | |
| Comparative | Composition 1 | 10 | 0.50 | <2 | 23.0 | 63.5 | 5.5 | 8.0 |
| Example 3 | | | | | | | | |
| Example 7 | Composition 1 | 20 | 0.50 | <2 | 23.0 | 62.5 | 6.5 | 8.0 |
| Example 2 | Composition 1 | 30 | 0.50 | <2 | 23.0 | 62.0 | 7.0 | 8.0 |
| Example 8 | Composition 1 | 60 | 0.50 | <2 | 18.0 | 62.0 | 12.0 | 8.0 |
| Comparative | Composition 7 | 30 | 0.50 | <2 | 24.0 | 66.0 | 6.0 | 4.0 |
| Example 4 | | | | | | | | |
| Example 2 | Composition 1 | 30 | 0.50 | <2 | 23.0 | 62.0 | 7.0 | 8.0 |
| Example 9 | Composition 5 | 30 | 0.50 | <2 | 12.0 | 55.0 | 20.0 | 13.0 |
| Example 10 | Composition 6 | 30 | 0.50 | <2 | 10.0 | 40.0 | 30.0 | 20.0 |
| Example 11 | Composition 6 | 60 | 0.50 | <2 | 10.0 | 35.0 | 35.0 | 20.0 |
| Example 2 | Composition 1 | 30 | 0.50 | <2 | 23.0 | 62.0 | 7.0 | 8.0 |
| Example 12 | Composition 1 | 30 | 0.50 | 20 | 10.0 | 55.0 | 25.0 | 10.0 |
| Example 13 | Composition 1 | 30 | 0.50 | 70 | 10.0 | 53.0 | 27.0 | 10.0 |
| Example 14 | Composition 1 | 30 | 0.50 | 100 | 10.0 | 50.0 | 30.0 | 10.0 |

| | Feldspar | | | | |
|---|---|---|---|---|---|
| | crystal | | | | |
| | phases/Non- | | Al₂O₃ | Relative | |
| | crystalline | | phase | permittivity | Strength |
| | glass phases | Sinterability | bonding | ε | (MPa) |
| Comparative | 0.11 | Unsatisfactory | Unavailable | 5.30 | 85 |
| Example 1 | | | | | |
| Example 1 | 0.11 | Satisfactory | Available | 5.50 | 135 |
| Example 2 | 0.11 | Satisfactory | Available | 5.50 | 135 |
| Example 3 | 0.11 | Satisfactory | Available | 5.50 | 130 |
| Example 4 | 0.11 | Satisfactory | Available | 5.50 | 130 |
| Example 5 | 0.11 | Satisfactory | Available | 5.70 | 103 |
| Example 2 | 0.11 | Satisfactory | Available | 5.50 | 135 |
| Example 6 | 0.11 | Satisfactory | Available | 5.40 | 110 |
| Comparative | 0.11 | Unsatisfactory | Unavailable | 5.35 | 90 |
| Example 2 | | | | | |
| Comparative | 0.09 | Satisfactory | Unavailable | 5.41 | 80 |
| Example 3 | | | | | |
| Example 7 | 0.10 | Satisfactory | Available | 5.45 | 105 |
| Example 2 | 0.11 | Satisfactory | Available | 5.50 | 135 |
| Example 8 | 0.19 | Satisfactory | Available | 5.65 | 145 |
| Comparative | 0.09 | Satisfactory | Unavailable | 5.30 | 80 |
| Example 4 | | | | | |
| Example 2 | 0.11 | Satisfactory | Available | 5.50 | 135 |
| Example 9 | 0.36 | Satisfactory | Available | 5.73 | 160 |
| Example 10 | 0.75 | Satisfactory | Available | 5.90 | 185 |
| Example 11 | 1.00 | Satisfactory | Available | 6.10 | 190 |
| Example 2 | 0.11 | Satisfactory | Available | 5.50 | 135 |
| Example 12 | 0.45 | Satisfactory | Available | 5.65 | 225 |
| Example 13 | 0.51 | Satisfactory | Available | 5.68 | 220 |
| Example 14 | 0.60 | Unsatisfactory | Available | 5.40 | 190 |

In Examples 1 to 4 and Comparative Example 1, the average grain size of the SiO₂ fillers was changed. In Comparative Example 1, in which the SiO₂ fillers had a small average grain size, the sinterability was unsatisfactory, and there were no Al₂O₃ phases bonded via the feldspar crystal phases. This resulted in reduction of the strength. In Example 4, in which the SiO₂ fillers had a large average grain size, it was confirmed that the surface roughness was reduced more than in Examples 1 to 3 and Comparative Example 1, when the glass ceramic was processed into a sheet.

In Examples 5 and 6 and Comparative Example 2, the proportion of the SiO₂ filler raw material was changed from that of Example 2 to change the area ratio of each phase without changing the value calculated by dividing the area ratio of the feldspar crystal phases by the area ratio of the non-crystalline glass phases. In Comparative Example 2, in which the proportion of the SiO₂ filler raw material was too large, the sinterability was unsatisfactory, and there were no Al₂O₃ phases bonded via the feldspar crystal phases. This resulted in reduction of the strength.

In Examples 7 and 8 and Comparative Example 3, heating time was changed from that of Example 2 to change the value calculated by dividing the area ratio of the feldspar crystal phases by the area ratio of the non-crystalline glass phases without significantly changing the area ratio of the SiO₂ phases and the area ratio of the Al₂O₃ phases. In Comparative Example 3, in which the heating time was too short, the value calculated by dividing the area ratio of the feldspar crystal phases by the area ratio of the non-crystalline glass phases decreased. This resulted in nonexistence of the Al₂O₃ phases bonded via the feldspar crystal phases and reduction of the strength.

In Comparative Example 4, the crystallized glass was increased and the Al₂O₃ filler raw material was decreased from those of Example 2. In Examples 9 and 10, the crystallized glass and the SiO₂ filler raw material were decreased from those of Example 2, and the Al₂O₃ filler raw material was increased from that of Example 2. That is, in Comparative Example 4 and Examples 9 and 10, the composition was changed from that of Example 2 to change the value calculated by dividing the area ratio of the feldspar crystal phases by the area ratio of the non-crystalline glass phases. Further, in Example 11, the heating time was increased from that of Example 10 to increase the value calculated by dividing the area ratio of the feldspar crystal phases by the area ratio of the non-crystalline glass phases.

According to Examples 2 and 9 to 11 and Comparative Example 4, as the value calculated by dividing the area ratio of the feldspar crystal phases by the area ratio of the non-crystalline glass phases increased, the relative permittivity ε and the strength increased. In Comparative Example 4, the value calculated by dividing the area ratio of the feldspar crystal phases by the area ratio of the non-crystalline glass phases decreased. This resulted in nonexistence of the Al₂O₃ phases bonded via the feldspar crystal phases and reduction of the strength.

In Examples 12 to 14, the average aspect ratio of the Al₂O₃ filler raw material was changed from that of Example 2 to change the average aspect ratio of the Al₂O₃ fillers. In Examples 12 and 13, in which the Al₂O₃ fillers had an average aspect ratio of 15 or more and 75 or less, the strength was particularly increased from that of Example 2, in which the Al₂O₃ fillers had an average aspect ratio of less than 15. In Example 14, in which the Al₂O₃ fillers had an average aspect ratio of over 75, the sinterability was unsatisfactory, and the strength decreased from that of Examples 12 and 13. However, Example 14 had good relative permittivity ε and good strength.

### Experiment 2

Experiment 2 was conducted under the same conditions as in Example 2 of Experiment 1 except that the metal element mainly included in the crystallized glass in the glass raw material was changed from Sr to Mg, Ca, or Ba. Table 3 shows the results.

TABLE 3

| | | Average | | | Phase area ratio | | | |
|---|---|---|---|---|---|---|---|---|
| | | grain | Average | | | Non- | | |
| | | size of | aspect | | | crystalline | Feldspar | |
| | | SiO₂ | ratio of | Heating | SiO₂ | glass | crystal | Al₂O₃ |
| | | fillers | Al₂O₃ | time | phases | phases | phases | phases |
| | Composition | (μm) | fillers | (min) | (%) | (%) | (%) | (%) |
| Example 2 | Composition 1 | 0.50 | <2 | 30 | 23.0 | 62.0 | 7.0 | 8.0 |
| Example 21 | Composition 1 | 0.50 | <2 | 30 | 23.0 | 62.0 | 6.7 | 8.0 |
| Example 22 | Composition 1 | 0.50 | <2 | 30 | 23.0 | 62.0 | 7.0 | 8.0 |
| Example 23 | Composition 1 | 0.50 | <2 | 30 | 23.0 | 61.0 | 8.0 | 8.0 |

| | Feldspar | | | | | |
|---|---|---|---|---|---|---|
| | crystal | Metal | | | | |
| | phases/Non- | element | | | | |
| | crystalline | in glass | | Al₂O₃ | Relative | |
| | glass | raw | | phase | permittivity | Strength |
| | phases | material | Sinterability | bonding | ε | (MPa) |
| Example 2 | 0.11 | Sr | Satisfactory | Available | 5.50 | 135 |
| Example 21 | 0.11 | Mg | Satisfactory | Available | 5.30 | 110 |
| Example 22 | 0.11 | Ca | Satisfactory | Available | 5.45 | 120 |
| Example 23 | 0.13 | Ba | Satisfactory | Available | 6.00 | 145 |

Changing the metal element mainly included in the crystallized glass from Sr to Mg, Ca, or Ba resulted in the change of the metal element mainly included in the feldspar crystal phases from Sr to Mg, Ca, or Ba.

Examples 21 to 23, in which the metal element mainly included in the feldspar crystal phases was changed from Sr to Mg, Ca, or Ba, had good characteristics. In Examples 21 and 22, in which the metal element was changed to Mg and Ca respectively, the strength decreased from that of Example 2. In Example 23, in which the metal element was changed to Ba, the relative permittivity e increased from that of Example 2.

In all Examples of Experiments 1 and 2, it was confirmed that 25% or more of the Al₂O₃ phases 14 were bonded together via the feldspar crystal phases 13 in terms of the number of the Al₂O₃ phases 14.

### NUMERICAL REFERENCES

1 . . . glass ceramic
11 . . . SiO₂ phase
12 . . . non-crystalline glass phase
13 . . . feldspar crystal phase
14 . . . Al₂O₃ phase

What is claimed is:

1. A glass ceramic comprising:
feldspar crystal phases;
non-crystalline glass phases;
Al₂O₃ phases; and
SiO₂ phases, wherein
at least one pair of the Al₂O₃ phases is bonded via at least one of the feldspar crystal phases.

2. The glass ceramic according to claim 1, wherein
the feldspar crystal phases mainly comprise Sr.

3. The glass ceramic according to claim 1, wherein
Al₂O₃ fillers of the Al₂O₃ phases have an average aspect ratio of 15 or more and 75 or less.

4. The glass ceramic according to claim 1, wherein
SiO₂ fillers of the SiO₂ phases have an average grain size of 0.10 μm or more and 3.0 μm or less.

5. The glass ceramic according to claim 1, wherein
a value calculated by dividing an area ratio of the feldspar crystal phases by an area ratio of the non-crystalline glass phases is 0.10 or more and less than 1.00.

6. The glass ceramic according to claim 1, wherein
an area ratio of the Al₂O₃ phases is 7.0% or more and 20.0% or less.

7. The glass ceramic according to claim 1, wherein
an area ratio of the SiO₂ phases is 10.0% or more and 30.0% or less.

8. An electronic component comprising the glass ceramic according to claim 1.
